(19) United States
(12) Patent Application Publication
(10) Pub. No.: US 2026/0152664 A1
(43) Pub. Date: Jun. 4, 2026

(54) Use of a Coating System as a Durable Anti-Slip Coating of Surfaces

(71) Applicant: Porviva BV, Heerlen (NL)

(72) Inventors: Stefan Andreas Krayer, Langenfeld (DE); Tim Peter Pleyers, Würselen (DE); Gerd Josef Pleyers, Würselen (DE)

(21) Appl. No.: 19/126,680

(22) PCT Filed: Nov. 3, 2023
(86) PCT No.: PCT/EP2023/080680

§ 371 Date: May 2, 2025

(30) Foreign Application Priority Data
Nov. 4, 2022 (DE) 10 2022 004 120.0

(51) Int. Cl. C09D 175/04; C09D 7/40; C09D 7/65

(52) U.S. Cl. CPC C09D 175/04; C09D 7/65; C09D 7/69; C09D 7/70

(57) ABSTRACT

The present disclosure relates to the use of a coating system as a very durable anti-slip coating of surfaces, for example of floors.

### CROSS-REFERENCE TO RELATED APPLICATION

This application is the United States national phase of International Application No. PCT/EP2023/080680 filed on Nov. 3, 2023, and claims priority to German Patent Application 10 2022 004 120.0 filed on Nov. 4, 2022, the disclosures of each of which are hereby incorporated by reference herein in their entireties.

### BACKGROUND

### Technical Field

The present invention relates to the use of a coating system as a very durable anti-slip coating of surfaces, for example of floors.

### Technical Considerations

To prevent slipping, slip-resistant surfaces are realized according to the applicable regulations. Standard implementations are as follows:
Roughly manufactured concrete surfaces, such as
embossed natural stone,
blasted surfaces,
milled surfaces,
concrete/mortar surfaces with broom finish
Tiles having rough surfaces with
coarse texture (including pyramid-shaped),
fine texture
Coating systems filled with aggregates or sprinkle-type coating systems.

These are implemented individually or in combination with each other.

The rapid deterioration of grip, i.e., the “anti-slip” property, of conventional surfaces is mainly due to the rapid degradation and consequent loss of micro-roughness and, in addition, also partial loss of macro-roughness. This can then lead to the formation of undesirable “aquaplaning.”

### SUMMARY

### Object of the Present Disclosure

Since the durability of the slip resistance of existing coating systems can be considered inadequate, the task is to provide a coating
which exhibits an adjustable slip resistance and
has long-lasting performance
   and which
meets the highest slip resistance requirements on dry surfaces, wet surfaces, and oily surfaces, and
can be colored as desired and
is comfortable to walk on barefoot.

### Description

This task is solved by using a coating system as disclosed herein.

All known substrates can be used as substrates. Examples of such substrates comprise building surfaces such as walls/facades, roofs, floors, and/or furniture. Examples of substrate materials comprise wood, metal, ceramics (comprising quartz glass), concrete, stone (e.g., natural stone), and/or combinations of two or more of these materials.

In a first step, the impregnating material can be “glued” to any known substrate surface, and it does not have to be completely hardened. Particulate material is then applied to the substrate, which is covered with the impregnating material layer and glued thereon. Since the impregnating material is liquid or at least not completely hardened, the particulate material can be at least partially embedded in it and attached thereto.

Any material that has an adhesive effect and a corresponding surface tension so that it can be applied to the substrate can be used as an impregnating material. Examples comprise adhesives, impregnating agents, primers, and/or the like. Preferably, this material is applied in a liquid state and then allowed to initially react, but not completely, before the particulate material is glued thereon.

According to some non-limiting aspects, the coating may further comprise a top layer covering an upper surface of the coating.

According to some non-limiting aspects, the coating may comprise at least two successive layers of impregnating material to which the particulate material adheres.

According to some non-limiting aspects, the second layer is applied after the first layer has reacted completely or has not yet completely reacted.

The particles of the particulate material applied to the impregnating material are positioned relative to each other in such a way that they create macro roughness. The fracture behavior of the edges of the particles generally possesses or retains its micro roughness during wear (fracture edges). The particles are therefore not “sanded round,” as is otherwise regularly observed with “sharp-edged” particles during use.

This effect can be achieved for example, but not exclusively, by using ordinary acrylic paint, which is crushed after hardening. Other alternatives are recycled plastics (e.g., PET), crushed micro-rough granite or other harder rock types, and/or corundum. These crushed particles can remain adhered to the impregnating material. In some non-limiting aspects, the crushed acrylic paint is recycled acrylic paint. Therefore, the particles used can be very environmentally friendly.

According to some non-limiting aspects, the particulate material can adhere to the impregnating material after the impregnating material has been applied to the substrate in a liquid or not completely reacted state. Capillary activity occurs as the impregnating material is sucked up, leaving cavities behind. Such quality ensures close contact so that at least a lower portion of the particulate material sinks into the impregnating material. It may happen that at least some particles of the particulate material have surfaces that protrude from the impregnating material. Where appropriate, the protruding particles can then be covered by a thin top layer of no more than 20 μm, which merely rounds off the gaps or corners and additionally fixes the particles.

According to some non-limiting aspects, voids may be provided between the particles of the particulate material, the volume of the voids not filled with the impregnating material being from 20 to 80, or from 30 to 50 percent by volume. The impregnating material can penetrate into the voids between the particles of the material. However, due to the structure of the material, some voids are not filled with impregnating material and may be filled with the surrounding atmosphere. Voids are free spaces between the particulate material particles within the layer made of the particulate material particles, which are empty, i.e., not filled with impregnating material and/or the material forming the top layer. Further possible volume proportions of the voids not filled with the impregnating material are 20 vol. %, 30 vol. %, 35 vol. %, 40 vol. %, or 50 vol. %. Each of these mentioned values can serve independently as an upper or lower limit, depending on the required surface properties.

According to some non-limiting aspects, the particulate material can be glued to the impregnating material to form an impregnating material layer and a particulate material layer with interlocking interfaces. Since the particulate material adheres to the impregnating material when it is in an initially reacted, but not yet fully reacted state, a substantially two-layer structure is formed, in which the impregnating material penetrates at an interface between the voids of the particles. This results in interlocking surfaces and a close contact, which consists of a layer with two sublayers of an impregnating material and a particulate material. These interlocking surfaces result in high wear resistance and durability of the coating over several years.

According to some non-limiting aspects, the coating may comprise at least two successive layers of impregnating material to which the particulate material adheres. The “anti-slip” effect can be improved if more than one of the layers of impregnating material and particulate material are present in successive layers. The top layer is glued to these layers.

According to some non-limiting aspects, the second layer can be applied after the first layer has reacted completely or has not yet completely reacted. In order to obtain the two-layer structure consisting of two layers of the impregnating material to which particulate material adheres, it is advantageous to first prepare the lower layer in the manner described above, i.e., first the impregnating material is glued to the substrate and then the particulate material is adhered to it. After this layer has been completed and the impregnating material has reacted at least largely or completely, a second layer is applied in the same manner, by first applying the impregnating material and then the particulate material to it.

According to some non-limiting aspects, particulate material in the first and second layers may consist of the same particulate material.

According to some non-limiting aspects, the impregnating material in the first and second layers may consist of the same material. For a simpler structure, the same material may be used as the impregnating material for the first and second layers. Any material that can be applied in a liquid state and is dried, hardened or cured at least after adhering the particulate material, can be used as impregnating material. For example, impregnating agents for concrete floors that are well known from the prior art can be used.

An example of such an impregnating material is described in DE 19828714 A1, which is incorporated by reference herein. The impregnating material can be any base or adhesive material, for example a low-viscosity two-component material, e.g., a two-component material based on epoxy resin, which can be used as an impregnating material. In a preferred embodiment, the impregnating material is made from a two-component material with an (initial) viscosity of less than 40 mPa*s (before hardening). In principle, any single-component or multi-component materials are suitable which have a low viscosity (preferably <40 mPa·s) and are free of solvents. These comprise, for example, low-viscosity epoxy resins consisting of solvent-free aliphatic, multifunctional reactive diluents, and amine-based aliphatic hardeners, which are mixed shortly before application. An example is a low-viscosity, two-component epoxy resin such as PORFIL.PLUS X pore filler lacquer (Porviva GmbH, Aachen, Germany). Alternatively, polyether-modified polyurethane prepolymers with isocyanate contents from 2 to 30% can be used, for instance, which are dispersed with 50 to 80 M.-% water immediately before application using suitable emulsifiers. The low viscosity represents a fundamental difference from known “stone carpets” and “sprinkled coating materials” with viscosities of more than 500 mPa s. The approach according to the present disclosure is essentially based on the use of binders with very low viscosity, which only wet the corners/contact points/contact surfaces of the scattered particles by capillary suction, thus creating a layer with a high cavity content.

According to some non-limiting aspects, the top layer can be a two-component polyurethane coating, preferably UV-stable and water-based. However, any coating that covers the protruding particles and offers high wear resistance can be used as the top layer.

According to some non-limiting aspects, the particulate material, preferably the comminuted acrylic paint, may comprise a binder, preferably acrylic-based, which is mixed with a (preferably UV-stable) pigment and at least one filler. Colored and/or reflective pigments may be used as pigments. For example, UV-resistant pigments can be used, either artificially produced or natural materials. Glass, quartz, natural stone powder, calcium carbonate, and/or barium sulfate can be used as fillers. As a binder for the material of which the particles are made, epoxy resin, polyurethane, or similar can be used as an alternative to the acrylic material (acrylic resin). In this case, the particulate material can be any material comprising the above-mentioned fillers, pigments, and binders. A particulate material of any known color can be used.

According to some non-limiting aspects, the particulate or granular material of the particle layer can be a flake-shaped particulate material. The terms “particulate” and “granular” are used interchangeably in the sense of the present disclosure. If a flake-shaped material is provided, this flake shape serves as a source of roughness if it is glued to the impregnating material. This forms stacked areas, with the particle flakes stacked such that the front and rear sides of such flakes are in close contact with each other, with the respective contact surface having an inclined configuration relative to the plane formed by the coating. This enables good micro- and macro-roughness, which improves the “anti-slip” functionality of the coating surface. According to some non-limiting aspects, the flakes of the flake-shaped particulate material may have an angular shape or also distinctly angular shape. The flake-shaped particulate material can be evaluated in terms of sphericity and roundness using the method of Krumbein and Sloss (Stratigraphy and Sedimentation, W H Freeman & Co; 2nd edition (Jan. 1, 1963)). In this method, the particles are examined visually and angularity as well as roundness are assigned different values between 0 and 1. A roundness of 1 means very low angularity (i.e., the particles are round), while a roundness of 0 means that the particles are distinctly angular.

The angularity can also be derived using an automatic method in which the radius of all edges of a respective particle is determined and the median radius of all edges is divided by the largest radius of the incircle of the particle. The more edges the particles have, the more the “anti-slip” effect can be improved. As the surface roughness increases, the contact area between the coating and the person coming into contact with the coating is reduced.

According to some non-limiting aspects, the particulate material can have a median particle size of 0.1 to 1 mm. Other possible average grain sizes comprise 0.2 mm, 0.3 mm, 0.4 mm, 0.5 mm, 0.6 mm, 0.7 mm, 0.8 mm, or 0.9 mm. Each of these values can serve independently as an upper or lower limit, depending on the required coating properties.

According to some non-limiting aspects, 10 to 50 wt. %, or 20 to 40 wt. %, preferably 25 to 30 wt. %, of the total particulate material contained may fall into a sieve fraction between 0.25 and 0.5 mm, and 10 to 50 wt. %, or 20 to 40 wt.-%, of the total particulate material may fall into a sieve fraction between 0.5 and 1 mm. In some non-limiting aspects, 5 to 20 wt. % of the total particulate material contained may fall into a sieve fraction between 1.00 and 1.25 mm. According to some non-limiting aspects, no more than 3 wt. % of the total material should fall into a sieve fraction of 0.125 mm or less, or no more than 1 wt. %. According to a further aspect, no more than 1 wt. % of the total material should fall into a sieve fraction of 1.25 mm or more, or no more than 0.5 wt. %.

The particulate material does not have to consist of particles of the same size. The aforementioned particle size distributions are also possible, too. The aforementioned size distribution can be easily achieved by comminuting the acrylic paint or recycled plastics or by breaking and specifically sieving rock-like materials such as granite or corundum.

According to some non-limiting aspects, the impregnating material for the second layer can be applied to the surface of the first layer with a specific weight of 170 g/m² to 230 g/m². The impregnating material of the base layer, which is in direct contact with the substrate, can also be applied in the aforementioned quantity. In this case, the substrate surface may be virtually non-porous. If a porous carrier material is used, the amount may be approximately 700 g/m² or more. In case of coating a porous substrate, the pores should preferably be filled with the impregnating material, and a residue should remain on the surface so that the particulate material can adhere to it.

According to some non-limiting aspects, the upper surface defined by the top layer may have a roughness value of 0.05 mm to 3 mm, or from 0.1 mm to 1.5 mm. Other possible roughness values comprise 0.5 mm, 1 mm, 2 mm, or 2.5 mm, among others. Each of the roughness values mentioned can independently serve as an upper or lower limit, depending on the required coating properties. The roughness is determined by standard methods. Tactile or optical measuring devices are primarily used as objective measuring methods for measuring the surface roughness. Depending on the measuring system, the measuring methods enable 2D or 3D (topography) evaluation. The measurement data can be recorded, stored, and analyzed. The exact procedure for measuring surface roughness with a tactile surface measuring device is described in ISO 4288:1996, to which reference is made here.

The inventors unexpectedly discovered that each of the above characteristics, either alone or in combination, results in an improved coating on a substrate that permanently maintains the measurable slip resistance (PTV values) at a very high level (>>50 PTV, preferably >65 PTV). The PTV test is a recognized test method for slip resistance/slip prevention of a surface in accordance with EN13036-4 (The pendulum test-European standard EN 13036-4:2011). The European standard EN 13036-4:2011 allows the classification of the slip resistance of all floors. To this end, the surface properties of a floor are determined under dry, wet, and/or oily conditions using a pendulum test. The danger of slipping and the potential risk of injury are measured. The pendulum test has proven itself and is considered reliable. Measurements are performed using a sliding piece attached to the end of a pendulum arm. This simulates the process of slipping and measures the sliding friction on the surface. The results are displayed on a measurement field scale, on which the pendulum test value (PTV) can be read.

The slip-resistant effect lasts for several years with normal use and care of the coated substrates, for example for at least 2, at least 5 or at least 10 years. If the surfaces are subsequently reworked (e.g., after approx. 5 years), the top sealing is preferably diluted with up to 5 parts by weight of water so as not to exceed dry film thicknesses of 5 μm. This ensures that the micro and macro roughness is maintained to a sufficient degree.

The present disclosure therefore preferably relates to the use of a coating on a substrate comprising an impregnating material which adheres to the substrate; a particulate material which adheres to the impregnating material or is partially incorporated therein; and a top layer covering an upper surface of the coating; wherein the particulate material is a flake-shaped material.

According to some non-limiting aspects, the coating may comprise at least two successive layers of impregnating material to which the particulate material adheres or is partially incorporated. According to a further aspect, the second layer is applied after the first layer has reacted or cured, but has not yet completely reacted.

The present disclosure also provides the use of a coating on a substrate, the coating comprising: a base material adhering to the substrate; and a particulate material adhering to the base material; wherein the particulate material has an angular or distinctly angular shape, so that the upper surface of the coating has a macro roughness of 0.05 mm to 3 mm. According to some non-limiting aspects, a base material is used which adheres to the substrate and to which particles with an angular or distinctly angular shape adhere, so that the upper surface of the coating has a macro roughness of 0.05 mm to 3 mm. The shape of the particulate or flake-shaped material allows the surface roughness (macro and micro roughness) to be adjusted, thereby reducing the contact area between the user and the coating. For example, an angular/distinctly angular material improves the roughness of the surface.

According to some non-limiting aspects, the material is used for coating various surfaces, for example building surfaces such as walls/facades, roofs, floors, or furniture, in particular floors.

### BRIEF DESCRIPTION OF THE DRAWINGS

FIG. 1 is a representative sectional view of a coating according to the present disclosure applied to a substrate;

FIG. 2 is a representative illustration of the relationship between the ratio of the different axes of the particles of the particulate material and their appearance;

FIG. 3 is a representative illustration of the relationship between the roundness (x-axis) and the sphericity (y-axis), wherein the roundness is a measure of the angular shape of the particles of the particulate material; and

FIG. 4 is a representative illustration of a further method for measuring the angularity of the particles of the particulate material.

### DETAILED DESCRIPTION

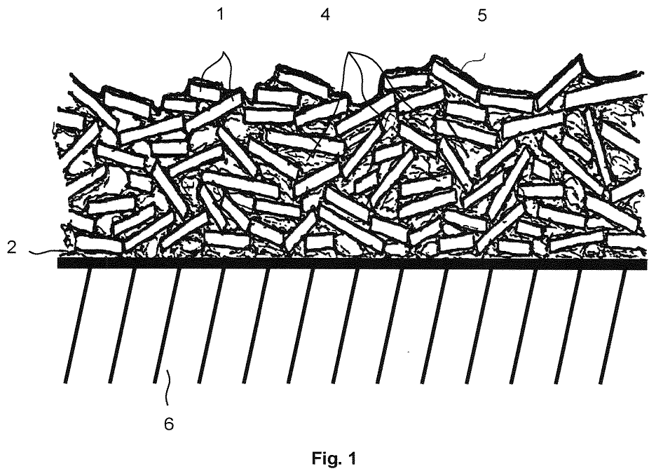

A schematic example of the coating according to the present disclosure on a substrate is shown schematically in FIG. 1. A particulate material, which in the present case is a flake material, is designated by reference numeral 1 in FIG. 1. After an impregnating material 3 has been applied to the substrate 2 (e.g., to the surface 6 of the substrate 2) in a first step, the flake material 1 is applied to the semi-hardened impregnating material 3. Since the impregnating material 3 is semi-hardened, this material flows at least partially into the voids 4 between the flake material and fills some of these voids 4 at least partially. A top layer 5 made of a sealing resin is applied to this coating made of the flake material 1 and the impregnating material. This top layer 5 covers the protruding edges of the flake material 1 and results in increased wear resistance and durability.

Various possible materials are discussed below, which should not be considered so as to limit the present disclosure.

Any material that can be applied in liquid form and hardens, reacts fully or dries after application can be used as an impregnating material. Such a material may be an impregnating material commonly used for covering and impregnating concrete or floor materials. A non-limiting example is a two-component epoxy resin.

After the two components have been combined, the impregnating material can be applied to the substrate in an amount of 10 to 200 g/m², preferably 50 g/m², 100 g/m² or 150 g/m². In this case, the substrate surface should be virtually non-porous. If a porous substrate material is used, the amount may be approximately 700 g/m² or more. When coating a porous substrate, the pores should be filled with the impregnating material and a residue should remain on the surface so that the particle material can adhere to it.

Any material with a flake-like appearance and/or any material that has an angular or distinctly angular shape, so that the upper surface of the coating has a roughness of 0.05 mm to 3 mm, can be used as the particulate material. Preferably, the particulate material is crushed acrylic paint or broken micro-rough granite or other harder rock types. As long as a flake-shaped material and/or a material with an angular or distinctly angular shape is used, its shape can be determined according to the following scheme.

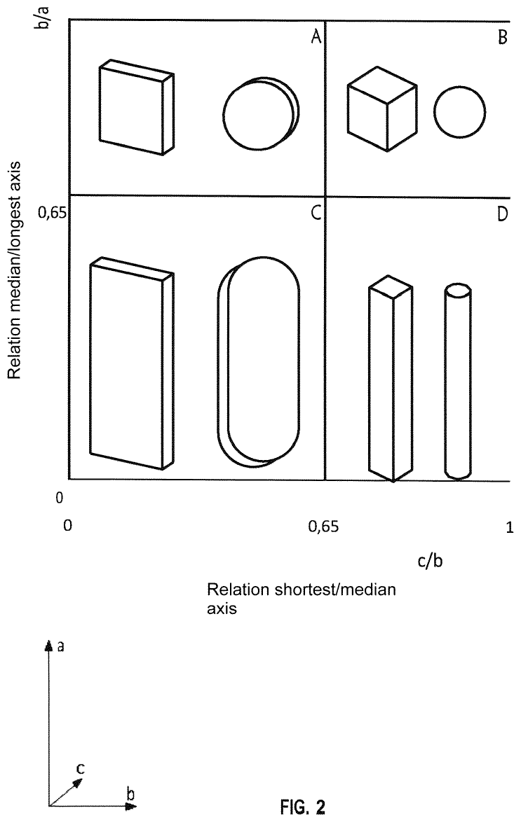

Each flake-shaped material is an idealized shape in which one axis is the longest axis, one axis is a median axis, and one axis is the shortest axis. This is shown in FIG. 2. Each flake material may have an envelope geometry corresponding to the examples of particles shown in FIG. 2. In FIG. 2, the axes a, b, and c denote the respective short axis (c), median axis (b), and long axis (a) of the particle. The plate shape of the particles can be characterized by the relationship between the axes and lengths. A ratio between the median axis b and the short axis c of 1 (see right quadrant D in FIG. 2) means that these axes are equal. A ratio of approximately 0 means that the shortest axis c is very short and the median axis b is longer than the shortest axis c (see quadrant C). On the horizontal axis in FIG. 2, the ratio between the shortest and the median axis is therefore between 0 and 1.

A further relationship can be established between the median axis b and the longest axis a, which is shown on the vertical axis. Since the ratio between the longest axis c and the median axis b is the same, this ratio is approximately 1 (see quadrant A).

The flake material is preferably a material in which the ratio between the shortest and the median axis c/b is 0 to 0.65 and in which the ratio between the medium and the longest axis b/a is 0 to 1 (quadrants A and C). It is preferred to also choose the ratio between the medium and the longest axis b/a to be 0 to 0.65. Further preferred ranges of the ratio between the shortest and the median axis a to b are 0.3 to 0.5.

The flake-shaped appearance increases the surface area to volume ratio. In addition, it was unexpectedly found that the higher the surface area to volume ratio, i.e., the more flake-shaped the particles are, the better the anti-slip function. Stacked areas are formed, with the particle flakes stacked such that the front and back sides of such flakes are in close contact with each other, with the respective contact surface having an inclined configuration relative to the plane formed by the coating. This enables good and durable surface roughness.

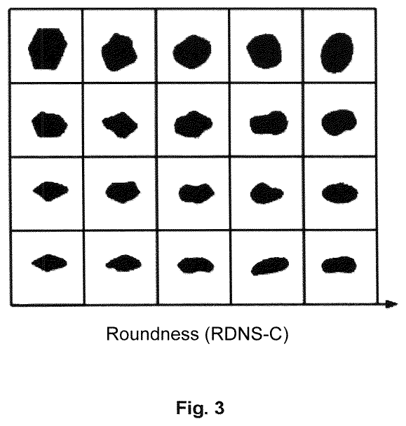

Another measure of morphology is the so-called angularity. This angularity can be evaluated by visual methods, e.g., according to the so-called Krumbein and Sloss method. A corresponding example for illustrating this methodology is shown in FIG. 3. On the horizontal axis, a scale of 0.0 to 1 is provided as a measure of roundness (which is a measure of angularity), while a scale of 0.0 to 1.0 for the so-called sphericity is provided on the vertical axis. Sphericity is a measure that indicates how spherical an object is.

Sphericity is a measure of how spherical (round) an object is. As such, it is a specific example for a measurement of the compactness of a shape. The sphericity of a particle is defined by the following formula:

$$Ψ = \frac{{{π}^{\frac{1}{3}} ( 6 {V}_{p} )}^{\frac{2}{3}}}{{A}_{p}}$$

In the above formula, Vp is the volume of the particle and Ap is the surface area of the particle. By definition, the sphericity of a sphere is equal to one (1.00), and according to the isoperimetric inequality, every particle that is not a sphere has a sphericity less than 1.

Roundness is a measure for the angularity of the particles. According to the methodology of Krumbein and Sloss, each particle is visually inspected and assigned to a field in the matrix in FIG. 3. Particles with a roundness of 0 to 0.2 (angularity of 1 to 0.8) are considered distinctly angular, particles with a roundness of 0.2 to 0.4 (angularity of 0.8 to 0.6) are considered angular, particles with a roundness of 0.4 to 0.6 (angularity of 0.6 to 0.4) are considered subangular, particles with a roundness of 0.6 to 0.8 (angularity of 0.4 to 0.2) are referred to as rounded, and particles with a roundness of 0.8 to 1.0 (angularity of 0.2 to 0.0) are referred to as well rounded.

In the present case, it is preferred that the appearance of the flake material is at least angular (roundness below 0.4). In some non-limiting embodiments, it is preferred that the roundness is distinctly angular (roundness below 0.2).

The higher the angularity of this flake material, the rougher the surface of the coating. On the other hand, the angularity ensures a corresponding distance between adjacent particles, so that corresponding voids are created. This results in a structure that is not too compact. The open structure, which is not too compact, improves the macro-roughness of the surface. The more edges, surface roughness, and voids the surface has, the more the effect against aquaplaning can be improved.

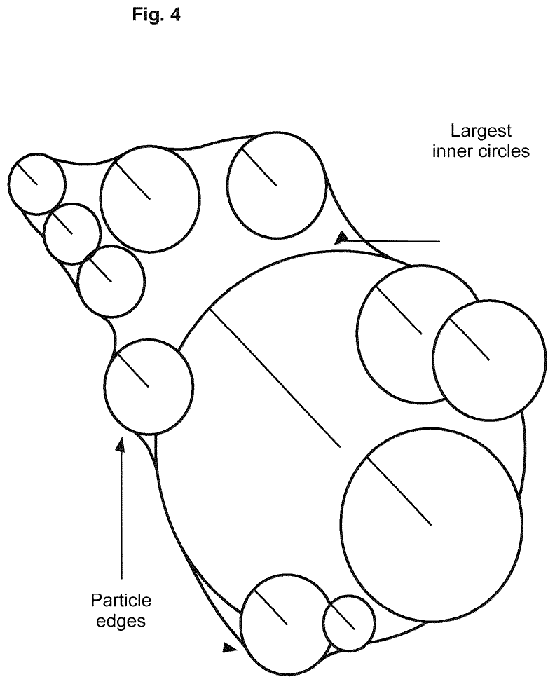

The angularity can also be derived by an automatic method, as shown schematically in FIG. 4, the radius of all edges of a respective particle being determined and the median radius of all edges being divided by the largest radius of the inner circle of the particle.

As shown in FIG. 4, the radii of all edges of the particles, viewed in a plane, are determined and the median radius of all edges is calculated. This median radius is divided by the radius of the largest incircle within the particle. The ratio obtained is a measure of angularity. The higher the angularity, the lower the value (approximately 0), and the lower the angularity, the higher the value (approximately 1). “Distinctly angular” means a value of 0.0 to less than 0.2, and angular means a value of 0.2 to 0.4. The values determined using the mentioned methodology are similar to those determined using the methodology of Krumbein and Sloss. The angular/distinctly angular material improves the roughness of the surface that can be coated with the top layer.

The flake materials preferably have a thickness of 50 μm to 150 μm, other preferred thicknesses are 80, 100, 115, 120, 130 μm. The respective thicknesses may each represent an upper or lower limit for a thickness. The respective thickness is to be selected with regard to the heat conduction requirements.

The so-called apparent density of the particulate material (i.e., the mass of the material in relation to the volume comprising the voids in the material) is preferably in the range of 2000 kg/m³ to 2800 kg/m³. Further preferred values for the bulk density are 2100, 2200, or 2400 kg/m³. The respective bulk density may represent an upper or lower limit.

The so-called external density, which represents the ratio between the mass of the material and the volume after the material has been poured onto a surface, should preferably be in the range of 1000 to 2000 kg/m³, with preferred values of 1100, 1200, 1300, 1400, 1500, 1600, 1700, or 1800 kg/m³. These specified values for the external density can each represent an upper or lower limit independently of each other.

The pore volume of the loose flake material can preferably be 25 to 50 percent by volume, or 35 to 45 percent by volume or approximately 40 percent by volume.

In addition to or as an alternative to the flake-like appearance, the particulate material may preferably consist of an acrylic paint or rock, plate-shaped and/or flat recycled plastics (PET, etc.) that are comminuted. Any known acrylic paint, comprising recycled acrylic paint, may be used. Before crushing the material, e.g., the acrylic paint, the material, e.g., the acrylic paint, should be hardened and then subjected to a crushing process. Preferably, the crushing process is also applied to an acrylic resin layer or a film.

The crushed material may consist of an acrylic-based binder mixed with a UV-stable pigment and at least one filler. Colored and/or reflective pigments can be used as pigments. For example, UV-resistant pigments can be used, either artificial or natural. Glass, quartz, natural stone powder, calcium carbonate, and/or barium sulfate can be used as fillers. As a binder for the material of which the particles are made, epoxy resin, polyurethane, or similar materials can be used as an alternative to the acrylic material (acrylic resin). In this case, the particulate material may be any material comprising the above-mentioned fillers, pigments, and/or binders. A particulate material of any known color can be used.

Instead of an acrylic paint, another particulate material of any known color can also be used. The particulate material may for example, have a specific particle size distribution as indicated in Table 1 below.

TABLE 1

| Particle size / sieve fraction(mm) | Amount (vol. %) |
|---|---|
| 0.00-0.125 | 0-3.0 |
| 0.125-0.25 | 2.0-10.0 |
| 0.25-0.50 | 25.0-40.0 |
| 0.50-1.00 | 25.0-40.0 |
| 1.00-1.25 | 5.0-20.0 |
| >1.25 | <1.0 |

This means that approximately 0 to 3 vol. % fall into a sieve fraction from 0.00 and 0.125 mm, 2 to 10 vol. % fall into a sieve fraction from 0.125 to 0.25 mm, 25 to 40 vol. % falls into a sieve fraction from 2.25 to 0.50 mm and approximately 25 to 40 vol. % fall into a sieve fraction from 0.5 and 1.0 mm, 5 to 20 vol. % fall into a sieve fraction from 1.00 and 1.25 mm and less than 1% fall into a sieve fraction larger than 1.25 mm.

After the particulate material has been adhered to the impregnating material, a top layer can be applied. The top layer forms a sealing layer and can prevent the particles from detaching. This sealing layer (i.e., the top layer) can be a pore-filling top layer that at least partially fills the pores of the particulate material, a low-viscosity (e.g., «80 mPa*s) two-component resin, a transparent coating, and a waterproof material. This coating may be a two-component polyurethane-based top layer. In some non-limiting examples, it is preferred that the top layer consists of a material other than the impregnating layer. The use of a top sealing with very low viscosity, e.g., with an active ingredient content from 2 to 25 vol. %, provides further mechanical stabilization and rounding of undercuts to increase cleanability. This layer exhibits a pronounced micro- and macro-roughness without any significant loss of micro- or macro-roughness of the underlying layer(s) and thus contributes to very good anti-slip properties. The top layer creates a closed surface that is easy to clean, slip-resistant, wear-resistant, and durable.

The coating of the substrate with the material according to the present disclosure is described as follows.

After applying the impregnating material to the substrate surface, e.g., with a paint roller, the particulate material is applied to it. To enable the particulate material to adhere, the impregnating layer may be half-reacted, half-cured or half-dry, or the particulate material can be applied immediately after application of the impregnating layer while it is still liquid.

The wet film thickness of the impregnating layer is, for example, 100 g/m²+/−50 g/m². If porous material, such as aerated concrete, is used as a substrate, the wet film thickness of the impregnating layer is, for example, 700 g/m². This impregnating layer is applied with a paint roller as a continuous layer.

The particulate materials can be blown onto the impregnating layer, e.g., using a high-pressure gun. If the impregnating layer is not yet hard after application to the substrate, the particulate material can sink into the impregnation material and the impregnation material can rise between the particulate materials, also due to capillary forces. This can create voids between the particles, with the volume of the voids not filled with the impregnating material being from 35 to 45 percent by volume. During the application of the particulate material to the impregnating material, the impregnating material can diffuse into the voids between the particulate material particles. However, due to the structure of the material, some voids are not filled with impregnating agent. If there are voids that are not filled with impregnating material, so that, e.g., air remains in the voids, this promotes the desired anti-slip properties or is at least not disturbing. A consistent “house of cards” structure, interspersed with voids throughout the entire surface, allows for newly exposed macro-roughness even when the surface is worn, i.e., also newly exposed micro-roughness on exposed particles that were not previously exposed. After the particulate material has adhered to the impregnating material, the layer produced is harder. Afterwards, the excess particles that do not adhere are then blown away.

The top layer can then be applied with a paint roller. The respective layer thicknesses can be the same as the above-mentioned layer thicknesses for the impregnating material. Alternatively, after the first layer has hardened, a second impregnating layer can be applied with a paint roller in a further step. After that, the particulate materials can be applied to the not yet hardened impregnating material of the second layer in a further step. After that, the corresponding top layer can be applied to such a two-layer structure.

It is also possible to provide more than these two layers containing an impregnating material in combination with particulate materials.

The substrate material can be any known substrate material, such as wood, metal, ceramics (comprising quartz glass), concrete, stone (e.g., natural stone), or combinations of two or more of these materials. The substrate can be, for example, a terrace floor, a roof, and/or the wall of a building, each of which may contain one or more substrate materials independently of each other.

The present disclosure is described in the following non-limiting examples, which are only intended to serve as illustrations, since numerous modifications and deviations are obvious to those skilled in the art.

### Example 1

The coating according to the present disclosure on a concrete surface consisted of an impregnation/primer layer of PORFIL.PLUS X pore filler lacquer and a top layer of PLEYERS.WB 800 GLOSS two-component polyurethane top layer, both commercially available from Porviva GmbH. The particulate flakes were made of commercially available acrylic lacquer.

The combination of the particles of crushed acrylic paint and/or the angular material and/or the flake-shaped material embedded in the impregnating layer fulfills two functions.

It creates
macro-roughness due to the type of layering
   and
micro-roughness due to the fracture behavior of the wholly or partially embedded particles.

Only the durable preservation of the macro- and micro-roughness is the necessary condition for a permanently effective “anti-slip” effect.

1. A coating for coating on a substrate, the coating comprising:
at least one layer comprising an impregnating material which adheres to the substrate;
a particulate material adhering to and/or incorporated into the impregnating material, wherein the particulate material adheres to and/or sinks into the impregnating material when the impregnating material is in a liquid or partially cured state after application to the substrate,
and
a top layer covering an upper surface of the coating;
wherein the coating provides a multiyear slip resistance on the substrate surface of >50 PTV.

2. The coating according to claim 1, wherein there are voids between the particles of the particulate material, the volume of the voids not filled with the impregnating material being 30 to 50 percent by volume.

3. The coating according to claim 1, wherein the top layer is a two-component polyurethane lacquer.

4. The coating according to claim 1, wherein the particulate material comprises crushed acrylic paint.

5. The coating according to claim 4, wherein the crushed acrylic paint comprises an acrylic-based binder mixed with a pigment and at least one filler.

6. The coating according to claim 1, wherein the particulate material is broken micro-rough granite or corundum.

7. The coating according to claim 1, wherein the particulate material comprises a granular material with a median particle size of 0.1 to 1 mm.

8. The coating according to claim 1, wherein 20 to 40 wt. % of the total particulate material contained falls into a sieve fraction from 0.25 to 0.5 mm, 25 to 40 wt. % of the total particulate material falls into a sieve fraction from 0.5 to 1 mm, and no more than 3 wt. % of the total specified material falls into a sieve fraction of 0.125 mm or less and/or no more than 1 wt. % of the total specified material falls into a sieve fraction of 1.25 mm or larger.

9. The coating according to claim 1, wherein the upper surface defined by the top layer has a roughness between of 0.05 mm to 3 mm.

10. The coating according to claim 1, wherein the coating comprises at least two layers of impregnating material, the second layer being applied after the first layer has partially or completely reacted and the particulate material has been applied.

11. The coating according to claim 1, wherein the impregnating material comprises adhesive(s), impregnating agent(s), and/or primer(s).

12. The coating according to claim 1, wherein the impregnating material can be applied to the substrate in an amount of 10 to 200 g/m².

13. The coating according to claim 1, wherein the coating comprises at least two successive layers of impregnating material to which the particulate material adheres.

14. The coating according to claim 13, wherein a second layer is applied after a first layer has reacted completely or has not yet completely reacted.

15. The coating according to claim 13, wherein more than one of the layers of impregnating material and particulate material are present in successive layers.

16. A method for applying a coating on a substrate, comprising:
adhering at least one layer comprising an impregnating material to the substrate;
adhering a particulate material to and/or incorporating the particulate material into the impregnating material, wherein the particulate material adheres to and/or sinks into the impregnating material when the impregnating material is in a liquid or partially cured state after application to the substrate,
and
applying a top layer covering an upper surface of the coating;
such that the coating provides a multiyear slip resistance on the substrate surface of >50 PTV.

17. The method according to claim 16, further comprising forming voids between the particles of the particulate material, the volume of the voids not filled with the impregnating material being 30 to 50 percent by volume.

18. The method according to claim 16, wherein the particulate material comprises crushed acrylic paint.

19. The method according to claim 16, wherein the particulate material comprises a granular material with a median particle size of 0.1 to 1 mm.

20. The method according to claim 16, wherein 20 to 40 wt. % of the total particulate material contained falls into a sieve fraction from 0.25 to 0.5 mm, 25 to 40 wt. % of the total particulate material falls into a sieve fraction from 0.5 to 1 mm, and no more than 3 wt. % of the total specified material falls into a sieve fraction of 0.125 mm or less and/or no more than 1 wt. % of the total specified material falls into a sieve fraction of 1.25 mm or larger.
